(19) United States
(12) Patent Application Publication
(10) Pub. No.: US 2004/0128025 A1
(43) Pub. Date: Jul. 1, 2004

(54) Automated merchandising dispenser

(76) Inventor: Steven A. Deal, Spring Valley, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/331,453

(22) Filed: Dec. 27, 2002

(51) Int. Cl. G06F 17/00

(52) U.S. Cl. 700/236

(57) ABSTRACT

An automated merchandising dispenser that forms an integral part of an automated merchandising system is disclosed. A dispenser enables a consumer to immediately locate and obtain desired items that may be customized according to at least size, color, and style. Inventory for a particular item is categorized and identified with a machine readable identifier. The machine readable identifier includes information identifying the item and customization criteria, such as size, color, and style. The consumer, via a user interface, enters criteria for the particular desired item and the merchandising dispenser searches inventory categorized using the machine readable identifier. Available inventory may immediately be dispensed to the consumer, either locally or to a remote location. The consumer may be immediately notified of out of stock items and may be offered alternative items or alternative purchasing modes. Inventory may be segregated and local to dispensers or may be centralized and routed to dispensers.

### BACKGROUND OF THE INVENTION

1. Field of the Invention

The invention relates to merchandising dispensers. More particularly, the invention relates to consumer directed automated merchandise dispensing.

2. Description of the Related Art

The manner in which goods are stocked, displayed, and sold to consumers has remained virtually unchanged for decades. A consumer that wishes to purchase an item typically goes into a mall or store to shop for the item. One or more stores may be configured to offer the particular item, or type of item sought by the consumer. Once at the store, the consumer typically searches through the store's inventory for the particular item. The consumer may have to search through numerous items that are found to be unsuitable prior to locating the desired item. When the consumer desires more than one item, the process must be repeated for each item.

As an example, a consumer may wish to purchase an item of clothing, such as a shirt of a particular size and color. The consumer may know of a store that offers shirts of the desired type, or may know of a general mall location in which stores offering shirts of the desired type may typically be found. After locating such a store, the consumer must search through racks or bins of clothing in order to try and locate the desired style, color and size. Although stores typically initially categorize items according to style, color, and size, the process of consumers removing items to view them or try them on typically results in the loss of much of the organization for the collection of items. Thus, clothing racks are often in a state of disarray. The lack of any true organization may result in the consumer failing to find the desired item even though it may be available in the store. Additionally, the consumer may incur a lengthy search only to learn that the desired item is not available.

To further compound matters, the desired item may be stocked in a warehouse area of the store that is not accessible to the consumer. After searching through the items on display in the store, the consumer may conclude that the desired item is not available when, in fact, it is readily stocked in the warehouse section of the store. Alternatively, after an unsuccessful search of the displayed items, the consumer may ask a store representative to search the warehouse portion of the store to see if the desired item is available. The store representative may then need to check the stock of the item to see if the desired item is stored in a warehouse portion of the store. If the store representative locates the desired item, the consumer may then purchase the item, or more typically, examine and possibly try on the item prior to purchase. Alternatively, the consumer's efforts to locate the item may be further frustrated if the store representative is unable to locate the desired item. In this situation, not only has the consumer's search been thwarted, the consumer has spent additional time waiting for the store representative to unsuccessfully search warehoused stock for the desired item.

For items such as shoes, the consumer may only be able to access store inventory by interfacing with a store representative because nearly all stock is stored in ‘back room’ locations inaccessible to the consumer. Requiring service from a store representative slows the ability of the consumer to locate and try on multiple items. Additionally, the consumer's experience varies depending on the number of other consumers being assisted by the store representative.

From a retailer's perspective, the typical merchandising structure has many disadvantages. The retailer needs to display nearly 100% of the inventory in consumer accessible racks, bins, or locations to minimize the number of store representatives needed to assist consumers in searching for warehoused items.

However, displaying nearly 100% of the inventory in consumer accessible locations, such as clothing racks, presents disadvantages. Consumers are often not motivated or careful to restock an item in precisely the same position from which it was removed. The careless restocking by the consumer results in the loss of organization in the clothing rack, which results in subsequent consumers handling more of the items in their quest for the desired items. Additionally, the organizational disarray results in lost sales caused by a consumer's inability to locate a desired item when it is actually available. To combat the organizational disarray caused by careless restocking, the retailer often has to dedicate personnel to restocking and reorganizing the various clothing racks.

Displaying nearly 100% of the inventory also exposes a greater volume of inventory to shrinkage. Inventory shrinkage may be attributable to a number of factors, including, but not limited to, damage and theft. When clothing or other inventory is exposed in locations accessible to consumers, there is a greater possibility of the product becoming soiled from, for example, numerous shoppers rummaging through clothing racks in search of a desired item, or children that may unintentionally soil the clothing stored on racks. Clothing may also fall from the racks and be soiled or otherwise damaged while lying on the floor. Additionally, clothing may inadvertently be damaged while stored in the display racks. Shoppers may unwittingly snag, tear, break, or otherwise damage items in the racks. Additionally, shoppers may unwittingly break or otherwise damage more fragile items such as dishes, glass items, and ornamental items.

Shrinkage may also occur as a result of theft. Displaying large quantities of inventory exposes the inventory to theft. Single items, or in some instances, large quantities of items may be stolen from displays in instances of theft. The retailer typically employs a system of personnel and hardware dedicated to thwarting this type of shrinkage.

Inventory that is typically stored in locations inaccessible by consumers, such as is typical for shoes, requires store representatives to retrieve items for customers. This limits the consumer's ability to quickly locate and purchase items and limits the retailer's ability to simultaneously service multiple consumers.

Alternative merchandising systems have been implemented in retail locations with varying degrees of success. Internet stores are a type of mail order store in which a consumer browses through listings in a catalog and fills out an order form based on the inventory shown in the catalog. The consumer then purchases the items on the order form and the order is filled at a centralized warehouse and delivered to the consumer. In the Internet based and mail order merchandising systems, the consumer cannot view or examine a sample of the items, much less try on particular garments or shoes prior to purchase. Additionally, there is a time delay, typically measurable in days or even weeks, from the time the consumer purchases the items to the time the purchases are delivered to the consumer.

Another alternative merchandising system is known as a catalog store. In a catalog store, a consumer may initially choose items from a catalog and enter these items in an order form and deliver the order form to the retailer so that it may be filled. The consumer has the option of actually going to a store to deliver the order form and purchase the goods. The retailer then immediately retrieves the requested goods from stock, if available, for immediate use by the consumer. Alternatively, the consumer may go to the catalog store and browse samples of the actual goods available in the catalog. Then the consumer fills out an order form and has the order filled after paying for the items. Thus, other than viewing samples of the items in the stores, the purchasing of goods parallels the system of ordering directly from the catalog. The catalog store system is not particularly conducive to merchandising items that are personalized in any way. For example, the catalog store is not conducive to merchandising clothing for which there may be many sizes, styles, and colors. A consumer in a catalog store is not afforded the opportunity to try on clothing prior to purchase. Additionally, the array of possible colors and styles for clothing makes displaying the various options prohibitive. The catalog store is also unable to quickly change available merchandise or continually update selections because of the catalog basis for the items on display and available for purchase. A catalog store is not able to quickly update and distribute catalogs to consumers as retail items become available, sell out of stock, or otherwise is no longer available.

What is needed is a merchandising system that provides the immediacy of a traditional retail outlet and simultaneously reduces the burden on the retailer of reorganizing inventory, providing individualized customer service personnel, and guarding against shrinkage.

### SUMMARY OF THE INVENTION

An automated merchandising dispenser and method that forms an integral part of an automated merchandising system is disclosed. The dispenser enables a consumer to immediately locate and obtain desired items. The desired items may be customized according to personalization criteria that may include at least size, color, and style. Inventory for a particular item is categorized and identified with a machine readable identification. The machine readable identification includes information identifying the item and customization or personalization criteria, such as size, color, and style. The consumer, via a user interface, enters criteria for the particular desired item and the merchandising dispenser searches inventory categorized using the machine readable identification. The user interface may be local to merchandise stock or may be remote from merchandise stock. Available inventory may immediately be dispensed to the consumer, either locally or to a remote location. The consumer may be immediately notified of out of stock items and may be offered alternative items or alternative purchasing modes. Inventory may be segregated and local to dispensers or may be centralized and routed to dispensers.

In a first aspect, a merchandise dispenser having a merchandise stock configured to store at least one item of merchandise is disclosed. Each item of merchandise stored in the merchandise stock is associated with a machine readable identification. The merchandise dispenser also includes a user interface configured to accept a request for a desired item and an inventory control module configured receive the request from the user interface and to compare the request to a record of merchandise available within the merchandise stock. The merchandise dispenser includes a merchandise selector in communication with the inventory control module that is configured to locate the desired item within the merchandise stock based in part on the machine readable identification associated with the desired item. The merchandise selector also is configured to retrieve the desired item from the merchandise stock and dispense the desired item.

The merchandise dispenser inventory control module may be configured to update the record of merchandise if the merchandise selector dispenses the desired item and may also be configured to update the record of merchandise when items of merchandise are added to the merchandise stock. The request for the desired item received by the merchandise dispenser may include customization criteria provided via the user interface, and the customization criteria may include a size, color, or style of the desired item.

In another aspect, a merchandise dispenser includes a merchandise stock configured to store at least one item of merchandise, where each item of merchandise associated with a machine readable identification. The machine readable identification associated with each item of merchandise is used to identify customization criteria for the associated item of merchandise. The merchandise dispenser also includes multiple user interfaces. Each user interface is configured to accept a request for a desired item. The request may include customization criteria. The merchandise dispenser also includes an inventory control module configured to receive the request any of the user interfaces and to compare the request to an electronic record of merchandise stored within the merchandise stock. A merchandise selector in communication with the inventory control module is configured to locate the desired item within the merchandise stock based in part on the machine readable identification associated with the desired item. The merchandise selector retrieves the desired item from the merchandise stock. A transport mechanism is configured to transport the desired item retrieved by the merchandise stock to a merchandise output and to dispense the desired item.

The merchandise stock may be configured to store items of clothing supported on hangers, where each hanger has the machine readable identification associated with the item of clothing supported by the hanger. Alternatively, the merchandise stock may be configured to store items of merchandise in individual bins, each individual bin labeled with the machine readable identification associated with the item of merchandise stored within the bin.

In still another aspect, a method of dispensing items of merchandise is disclosed. The method includes storing items of merchandise within a merchandise stock, where each item of merchandise is associated with a machine readable identification. A device performing the method then updates an electronic record of items of merchandise stored within the merchandise stock. The method then entails receiving an electronic request for a desired item and determining whether the desired item is stored in the merchandise stock. The act of determining whether the desired item is stored in the merchandise stock is performed by comparing the electronic request with items identified in the electronic record. A device executing the method also locates the desired item within the merchandise stock based in part on the machine readable identification. The method then results in the merchandise dispenser dispensing the item. The method may also include automatically updating the electronic record to indicate the desired item is no longer stored in the merchandise store. Additionally, when storing items of merchandise into a merchandise stock, the method may include receiving characteristics of each item of merchandise and identifying the characteristics with the machine readable identification.

### BRIEF DESCRIPTION OF THE DRAWINGS

The features, objects, and advantages of the invention will become more apparent from the detailed description set forth below when taken in conjunction with the drawings in which like reference characters identify correspondingly throughout and wherein:

FIG. 1 is a functional block diagram of an embodiment of a merchandising dispenser configured to dispense locally stocked items.

FIG. 2 is a functional block diagram of an embodiment of a merchandising dispenser configured to dispense centrally stocked items.

FIG. 3 is a functional block diagram of an embodiment of a merchandising dispenser configured to dispense centrally stocked items from a centralized location.

FIG. 4 is flowchart of an embodiment of an automated merchandise dispensing system.

### DETAILED DESCRIPTION OF EMBODIMENTS OF THE INVENTION

A merchandise dispensing system and method that overcomes many of the above-described disadvantages from both a consumer's perspective as well as a retailer's perspective is disclosed herein. The merchandise dispensing system, as disclosed herein, allows a retailer to stock items in an automated dispenser after associating the items with a machine readable identification (ID). The machine readable ID typically includes information relating to personalization criteria of the item. The personalization criteria may, for example, include the size, color, and style of a particular item. Once the merchandising dispenser is stocked, each of the machine readable IDs is read to create an electronic log, or record, of the inventory available to the merchandising dispenser.

One or more sample items may be displayed on the merchandising dispenser. A user is able to interact with an electronic interface on the merchandising dispenser in order to select an item to be dispensed. Typically, the user operates a graphical user interface that allows the user to select a particular item from an item database and may allow the user to enter personalization criteria. As before, the personalization criteria may include, for example, size, color, and style. As used herein, the term “user” typically refers to a shopper or consumer that uses the merchandising dispenser to locate items for purchase. However, the user may also include the retailer and personnel associated with the retailer.

The merchandising dispenser takes the user input and searches the electronic log for an item matching the user selection. If the search of the electronic log indicates the desired item is within the inventory available to the merchandising dispenser, the dispenser searches through the physical inventory to locate the item. The item is then dispensed to the user. The electronic log, or record, is updated as items are dispensed to users, such that the record maintains an accurate accounting of the available inventory.

Alternatively, if the search of the electronic log indicates that the desired item is not within the inventory available to the merchandising dispenser, the merchandising dispenser executes an alternative merchandising routine. The alternative merchandising routine may, for example, allow the user to order the item and have it delivered to a user identified location, inform the user of alternative store locations that have the item, or inform the user of alternative items that are similar in nature to the desired item. In this manner, the user is provided the desired item whenever it is available, and is provided purchasing alternatives if the item is not available. The user is thus saved from having to search through racks of clothing for a particular item and the retailer maximizes sale opportunities.

The merchandising dispenser, system of dispensing merchandise, and method of dispensing merchandise provide many advantages over the conventional options available. From a shopper's perspective, the disclosed system, apparatus, and method provide the ability to quickly obtain desired purchases. Alternatively, if the item is not available, the shopper may more quickly determine that the item is not available without having to search through numerous locations. The shopper may also be provided alternative goods or purchasing options if a desired item is not in stock. The item may be ordered, purchased, and routed for delivery to the shopper. The incidence of out of stock items may be decreased because the retailer is able to provide higher density merchandising. Alternatively, the retailer may provide the shopper a greater selection. Alternative goods and options may also be provided to the shopper even when the requested item is available. The types of goods and options provided to the user may vary depending on the type of item initially requested by the user. For example, a shopper requesting a particular shirt may be shown, or otherwise be made aware of, various other clothing items that may be compatible with the selected item. These other items may include pants, jackets, ties, and the like.

The system, apparatus, and methods disclosed herein also provide many advantages to the retailer. Inventory may be stocked in higher density thus allowing more inventory to be offered to shoppers. Additionally, accurate and rapid inventory control is available to the retailer. Merchandise stocked in the dispensers may be accounted for in an electronic database that is updated as new items are added or items are dispensed to purchasers. A retailer may compare the inventory shown to be stocked in the dispensers with inventory sold and inventory awaiting restocking to account for each item of inventory. The retailer can more easily manage re-ordering and inventory control. If the retailer sees that a particular item is highly popular, the retailer may be able to order additional quantities before any sales are lost due to stock outages. The reordering may even be automated depending on the status of the inventory. Because inventory control is maintained electronically, the need for store personnel to physically count inventory is greatly reduced.

Merchandise shrinkage is minimized. Although nearly 100% of merchandise is available to shoppers, bundles of inventory are not in open areas subject to theft. Additionally, security systems may be coordinated with the operation of the merchandising dispenser. Video systems may be configured to automatically capture merchandise dispensing, or suspiciously high dispensing rates of a particular item may trigger video surveillance. Such synchronization of security with merchandise dispensing allows shrinkage to be minimized while increasing the ability to identify and apprehend shoplifters and dishonest employees.

Additionally, because the majority of the inventory is stored in the merchandising dispensers and only requested items are dispensed to shoppers, there is less exposure of each item of merchandise, resulting in less wear and tear on the items. Shoppers do not need to rummage through display racks to find their desired items. Thus, the shopper only needs to handle the desired item. Shoppers do not handle any items where the desired item is not available. This is in contrast to conventional apparel display racks, where a shopper may handle every item before discovering that the desired size is not available.

Retailer productivity is increased overall. Clerks may seldom be required to check back room stock that is inaccessible to the shopper in an attempt to locate a desired item not on the sales floor. If the electronic inventory of the merchandising dispenser is connected to an electronic database of all store inventory, the shopper as well as store personnel may know that a desired item is within store inventory prior to searching back room stock.

In some of the merchandising dispenser embodiments, merchandise may be stocked in random order and need not be segregated by category. The ability to randomly stock items eliminates the need for personnel to, for example, initially stock clothing items on display racks in order of size and continually monitor and reorder the display rack to maintain the ordering.

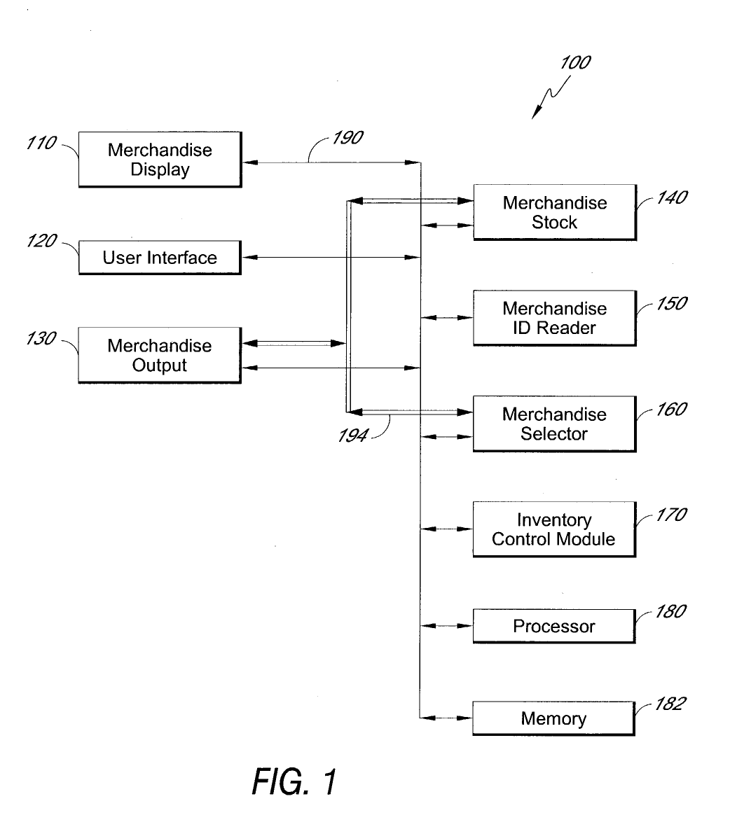

The retailer may desire a particular merchandise dispenser configuration in order to create a desired retail environment. One configuration is a sales floor stocked merchandise dispenser that dispenses requested items local to the dispenser. A functional block diagram of one embodiment of a locally stocked merchandise dispenser 100 is shown in FIG. 1.

The sales floor stocked merchandise dispenser 100 may be arranged on a sales floor in addition to, or as a replacement for, conventional merchandise displays. Stocking and merchandise dispensing is performed on the sales floor local to the merchandise dispenser 100. For example, in a clothing store, a merchandising dispenser 100 may be stocked with a single or select group of styles of clothing such as shirts. Alternatively, multiple styles may be stocked within a single merchandising dispenser. The merchandising dispenser 100 may then take the place of a conventional clothing display rack. Multiple merchandising dispensers may be used to eliminate some or all of the conventional clothing racks.

Each merchandising dispenser 100 may include a merchandise display 110. The merchandise display 110 may be as simple as a dedicated area on or near the remainder of the merchandising dispenser 100 for displaying actual samples of one or more items stocked in the merchandising dispenser 100. For example, a merchandising dispenser 100 configured to dispense shirts may have one or more sample shirts hanging near the front of the merchandising dispenser 100. In another embodiment, a merchandising dispenser 100 configured to dispense shoes may have a merchandise display 110 that is similar to a conventional shoe display, wherein a sample of each shoe style is placed in a location near the remainder of the merchandising dispenser 100. In another embodiment, the merchandise display 110 may provide a synthesized view of one or more items stocked in the merchandising dispenser 100. The synthesized view of the stocked merchandise may include one or more photographs, one or more slides, a three dimensional representation shown on a display, or a hologram. The merchandise display 110 may include a static display that does not change, a varying display that may update at periodic intervals, or an interactive display that demonstrates stocked merchandise in response to user commands. Additionally, the merchandise display 110 may include one or more of the embodiments discussed above or variations of the embodiments.

A shopper, or user of the merchandising dispenser 100, may examine the merchandise display 110 and wish to purchase or further examine an item stocked in the merchandising dispenser 100. Alternatively, the shopper may wish to try on an item of clothing before deciding on the purchase. The shopper navigates the user interface 120 to control the merchandising dispenser 100 to dispense the desired item. As discussed earlier, the user interface 120 may provide the user the ability to select an item and personalization characteristics associated with the item. The personalization characteristics may include such customizable features such as size, style, and color. The user submits the request to the merchandising dispenser 100 once all desired parameters have been entered. In one embodiment, the user can choose to immediately pay for the requested item, for example, by inserting a credit card or debit card into a card reader included in the user interface. The merchandising dispenser 100 may be configured to accept a single request or multiple requests prior to dispensing items.

After receiving one or more requests for items, the merchandising dispenser 100 processes the requests and, if the item is contained in the stock, dispenses the item to the user at a merchandise output 130. The merchandise output 130 is typically located near the user interface 120 to allow the user to enter requests and retrieve dispensed items from a single location. Of course, the merchandise output 130 may be placed in virtually any suitable location.

The merchandising dispenser 100 also includes a merchandise stock 140 area where the merchandise is stored for access by the merchandising dispenser 100. The merchandise stock 140 area may include a rack for hanging clothing or may include bins, shelves, or tubes for item storage. The merchandise stock 140 area is typically stocked by a store employee and is typically not accessible to the shopper. In general, those items shown on the right hand side of FIG. 1 are not accessible by the shopper. As described above, each item may have affixed a machine readable ID, or the storage bin or shelf may have a corresponding machine readable ID with which the item is associated. The merchandise stock 140 may be configured to move items in order to facilitate access to a particular item. Alternatively, the merchandise stock 140 may be static and may require navigation for retrieval of a particular item. Additionally, the merchandise stock 140 may have limited ability to move items and may require a limited level of navigation for retrieval of items.

A merchandise ID reader 150 may also be included within the merchandising dispenser 100. The merchandise ID reader 150 is configured to read the machine readable ID that is associated with each item stocked in the merchandising dispenser 100. The machine readable ID may be in the form of a bar code affixed to the item, a container for the item, a support for the item, or a location of the item. As was discussed above, the machine readable ID may be a bar code affixed to a hanger used to support items of clothing in the merchandise stock 140. The merchandise ID reader 150 may scan the ID as the hanger is passed in front of a stationary scanner. Alternatively, the merchandise ID reader may move to each item in order to scan the machine readable ID. The merchandise ID reader 150 may have limited range of movement, for example freedom only in the vertical direction, and columns of merchandise may be moved in front of the merchandise ID reader 150 for scanning of the codes. The merchandise ID reader 150 is typically used to locate a particular item for retrieval. However, the merchandise ID reader 150 may also be used to read the IDs of all stocked items in order to establish a complete inventory of items stocked within the merchandising dispenser 100. This may be useful when initially stocking the dispenser.

A merchandise selector 160 may also be included within the merchandising dispenser 100. The merchandise selector 160 operates in conjunction with the merchandise ID reader 150 to locate particular items from the merchandise stock 140. The merchandise selector 160 may then retrieve the item from the merchandise stock 140 for dispensing to the shopper via the merchandise output 130. In the example in which the merchandising dispenser 100 is configured to store and dispense shirts hung on hangers, the merchandise ID reader 150 reads the ID for stored items until the desired item is located. The merchandise selector 160 may then remove the shirt and hanger from the merchandise stock 140 and dispense the requested item to the shopper via the merchandise output 130. In this example, the merchandise output 130 may be an opening in which the shirt is presented, and from which the shopper may retrieve the shirt.

The merchandising dispenser 100 may also include an inventory control module 170 to track the inventory stored and available from the merchandising dispenser 170. The inventory control module 170 may include one or more storage devices for storage of the electronic log of the inventory stored within the merchandising dispenser 100. The inventory control module 170 may update the electronic log each time the merchandise stock 140 is accessed. For example, the merchandise stock 140 is accessed when a store employee stocks items in the merchandise stock 140. The inventory control module 170 may update the electronic log using manual or semi-automated data entered by the stocking employee. Alternatively, the inventory control module 170 may operate in conjunction with the merchandise ID reader to update the electronic log after the merchandise is stocked. The inventory control module 170 may control the merchandise ID reader 150 to read the machine readable ID from each item in stock once access to the merchandise stock is completed. For example, a store employee may open the merchandising dispenser 100 and stock items in the merchandise stock 140. Then, when the employee closes an access door following completion of stocking, the inventory control module 140 instructs the merchandise ID reader to scan the machine readable ID from each item in stock. The inventory control module 140 then updates the electronic log to allow for tracking of items within the merchandising dispenser 100. The inventory control module updates the electronic log as the merchandising dispenser 100 dispenses items at the request of shoppers. In this manner, the electronic log always keeps an accurate inventory of the items available in the merchandising dispenser 100.

Additionally, the inventory control module 170 may log usage of the merchandising dispenser 100. For example, the inventory control module 170 may be able to track quantities of a particular item dispensed, and may track changes in inventory each time the merchandise stock 140 is accessed by store personnel. The usage information may be downloadable from the merchandising dispenser 100 or may be communicated to another device (not shown) on a periodic basis, or based on the occurrence of an event. For example, the inventory control module 170 may communicate with a central database (not shown) each time inventory within the merchandising dispenser changes. As merchandise is stocked within the merchandising dispenser 100, the inventory control module 170 communicates the increase in items to the central database. If access to the merchandise stock 140 results in items being removed from the merchandise stock 140, this decrease is also reported to the central database. Decreases in merchandise stock attributable to items being dispensed to shoppers are also communicated to the central database. Thus, a retailer may track on virtually a real time basis the complete inventory within a store. If the retailer similarly communicates records of purchases to the central database, every item may be tracked. Items that are shown as not in inventory and not purchased may await restocking, such as items returned from dressing rooms or items left unpurchased by shoppers, or may be missing due to shrinkage. In this manner, a retailer may have the ability to identify, on a daily basis, shrinkage to the particular item.

The merchandising dispenser 100 typically includes a processor 180 and associated memory 182 that may be configured on a control board (not shown) or that may be configured in one or more of the previously discussed functional blocks. The memory 182 may store one or more processor readable programs that instruct the processor 180 to perform some or all of the tasks provided by the functional blocks. For example, the memory 182 may include processor readable code that instructs the processor 180 to control the user interface 120.

The processor 180 may communicate with the memory 182 over one or more communication paths 190. Additionally, each functional block may be in communication with another functional block over the communication paths 190. The communication paths 190 may be dedicated hardwired paths or may be shared buses routed to one or more of the functional blocks.

Additionally, one or more of the functional blocks may be mechanically interconnected with another functional block. FIG. 1 shows the mechanical interconnection of the merchandise selector 160 with the merchandise stock 140 and the merchandise output 120 using a mechanical interconnection 194. However, some or all of the other functional blocks may similarly be mechanically coupled using the same or separate mechanical interconnections.

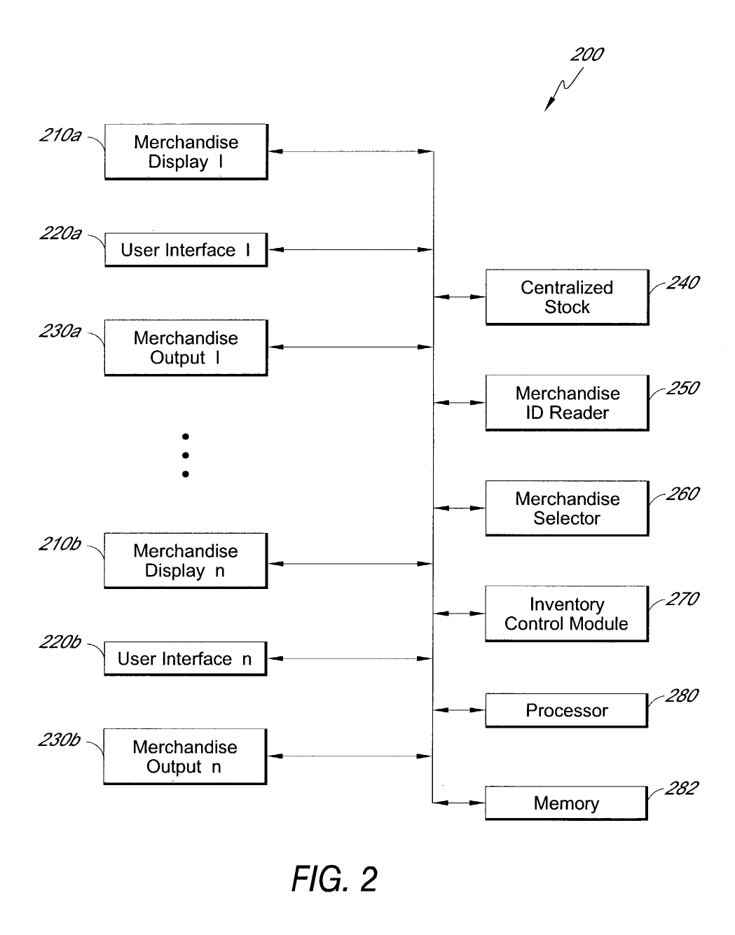

A merchandising dispenser that has both the stock and user interface local to the dispenser output is shown in FIG. 1. However, other embodiments of the merchandising dispenser may be implemented. FIG. 2 shows a functional block diagram of a merchandising dispenser 200 wherein multiple merchandise displays, user interfaces, and merchandise outputs are connected to a common inventory.

In the embodiment shown in FIG. 2, the merchandising dispenser is configured to provide distributed dispensing but stocking is performed in a centralized location. Alternatively, the merchandise may be stocked in distributed locations but may be accessible by multiple user interfaces and merchandise outputs. As an example, the entire inventory of one or more items may be loaded into the merchandising dispenser 200 in a location inaccessible to shoppers, such as a stockroom. Multiple merchandise displays, user interfaces, and merchandise outputs may be located throughout a retail area accessible to shoppers. A shopper may then use any of the user interfaces to request items from the merchandising dispenser 200 and have the items delivered to any of the merchandise outputs. A transport mechanism moves the desired items from the stock to the desired merchandise output. Typically, a shopper may have the merchandise dispensed at a merchandise output local to the shopper, such as an output adjacent to the user interface. However, a shopper may request the desired items be dispensed at a remote merchandise output, such as a dressing room or holding location for subsequent pick up.

In another example of the centralized stock embodiment shown in FIG. 2, a shopper may request items from different user interfaces, for example 220a and 220b, and direct the requested items to the same merchandise dispenser, for example 230b. A user may first request an item, such as a shirt or pair of pants, using a sales floor user interface, for example 220a. The shopper may request that the desired items be delivered to a specific merchandise output, for example 230b, that can be in a fitting room.

Alternatively, a user may request that the desired items be delivered to a fitting room and the merchandising dispenser 200 reserves a fitting room for the shopper and specifies the fitting room to the shopper using, for example the display on the user interface. Because the fitting room may be locked to prevent unauthorized retrieval of the desired items, the user may be provided a temporary code that allows access to the fitting room. Alternatively, if the user has a loyalty card or device, the fitting room may be reserved and accessed based on the identification provided in the loyalty card or device. The shopper may then go to the fitting room to try on the dispensed items. There may be another user interface, for example 220b, within the fitting room and the shopper may request other items using the fitting room user interface 220b. The shopper may request that these desired items be dispensed at the same fitting room merchandise output 230b. Thus, the shopper may be able to request alternative styles, sizes, or items without returning to the sales floor. Alternative mechanisms may be provided in the dressing rooms to allow the shopper to return undesired merchandise or purchase desired merchandise while in the fitting rooms.

For example, the user interface 230b placed in a fitting room can include a card reader or magnetic strip reader for accepting credit cards or debit cards. Additionally, the user interface 230b can accept cash, with a paper money reader, coin collector, or other means for accepting payment. The user can then request items via the user interface 220b and request the items be delivered to the merchandise output 230b in the fitting room. The fitting room can also include a return merchandise provision to allow a user to return merchandise that is not desired, such as clothing that does not fit. The user's credit or debit account can be, for example, automatically billed for merchandise that is delivered to the merchandise output 230b and not returned. This would allow a shopper to purchase and immediately wear a shirt or pair of pants upon departure if desired. This method of payment eliminates the need for a user to stand in a checkstand to pay for merchandise.

In another example of the centralized stock embodiment a user interface and merchandise output may be placed in a location outside the sales floor and outside of the store, such as at the storefront. Shoppers could then interact with the user device and have desired items dispensed to the outside location. This would allow a shopper access to the entire inventory outside of conventional store hours. Of course, because items may be dispensed outside of the store and outside of conventional store hours, prepayment may be required, such as by credit card, debit card, cash, or prepaid card, before items are dispensed. Thus, unlike a conventional vending machine, a shopper is provided access to an entire store inventory.

FIG. 2 shows a functional block diagram of a centralized stock embodiment of a merchandising dispenser 200. Functional blocks that are typically accessible to the user are shown on the left hand side of the figure, while functional blocks that are typically inaccessible to the user, or internal to the merchandising dispenser 200, are shown on the right hand side of the drawing.

Multiple merchandise displays 210a-210b are typically provided in an area accessible to the user. The user accessible areas may include shopping areas and fitting room areas, as well as areas external to the store. Multiple user interfaces 220a-220b and merchandise outputs 230a-230b may also be provided in user accessible areas. Typically, a merchandise display, for example 210a, is located within close proximity to a corresponding user interface, for example 220a, and merchandise output, for example 230a. However, it is not necessary for there to be a one to one correspondence between merchandise displays 210a-210b, user interfaces 220a-220b, and merchandise outputs 230a-230b. In a location such as a fitting room, there may be no need to provide a corresponding merchandise display.

In contrast to the locally stocked merchandising dispenser embodiment detailed in FIG. 1, the merchandising dispenser 200 embodiment of FIG. 2 utilizes a centralized stock 240. The centralized stock 240 represents a stock area that is connected to multiple user interfaces 220a-220b and merchandise outputs 230a-230b. Typically, all of the inventory for one or more items may be stored in the centralized stock 240. The centralized stock 240 may be located in a single location, such a single back room stock area of a store, or may be distributed among several locations. For example, the centralized stock 240 maybe distributed among multiple locations in a back room of a store or may be distributed among several floors of a store. In another example, stock may also be stored in a distributed fashion with a small quantity of stock local to the dispensers. An example of small stock local to the dispenser would be one size of each style and color combination of an item available from that dispenser. As users request items from the merchandising dispensers, the desired items are dispensed. A replacement item from centralized storage may then be routed and stored in the stock local to the dispenser. In this manner, the majority of stock is stored in the centralized location, but a user may immediately receive a desired item without having to wait for it to be transported from a centralized storage area. The centralized stock 240 allows a retailer to provide user access to a large inventory while reducing the need to constantly restock the merchandising dispenser 200. Conceivably, the entire inventory of a retailer could be stocked in the centralized stock 240 of one or more merchandising dispensers 240. The merchandising dispensers 200 may then substantially monitor the complete store inventory. If the electronic logs of the merchandising dispensers 200 are connected to a centralized database (not shown) a retailer could monitor, on nearly a real time basis, the entire store inventory.

Many of the other functional blocks included within the merchandising dispenser 200 operate in a manner analogous to the corresponding functional blocks described with respect to FIG. 1. For example, a merchandise ID reader 250 may be configured to read the machine readable ID affixed to the stocked merchandise or the merchandise storage location. A merchandise selector 260 operates to retrieve items requested from the centralized stock 240 and transport them to the merchandise output, for example 230b, identified by the user. A transport mechanism (not shown) is used to enable the requested merchandise to be directed to a merchandise output, and to traverse the distance from the centralized stock 240 to the desired merchandise output, for example 230b. The transport mechanism may include, but is not limited to, a series of pneumatic tubes, conveyer systems, moving loops, portable bins, motorized storage, and the like, or some other means for transport.

An inventory control module 270 may be used to track the location and presence of merchandise items stored in the centralized stock 240. Additionally, a processor 280 and memory 282 may be included to perform functions stored as processor readable instructions, such as those associated with the merchandising dispenser 200. These functions may include storage and updating of the electronic record, functions relating to the user interface, functions relating to inventory control, and functions relating to the operation of each of the functional blocks in the merchandising dispenser 200.

The merchandising dispenser 200 using centralized stock 240 allows a retailer to maintain substantially all of the available merchandise in the dispenser. The shopper is thus able to access substantially all merchandise from any of the user interfaces. The available sales area may be expanded by locating the centralized stock 240 in back room locations outside the sales floor.

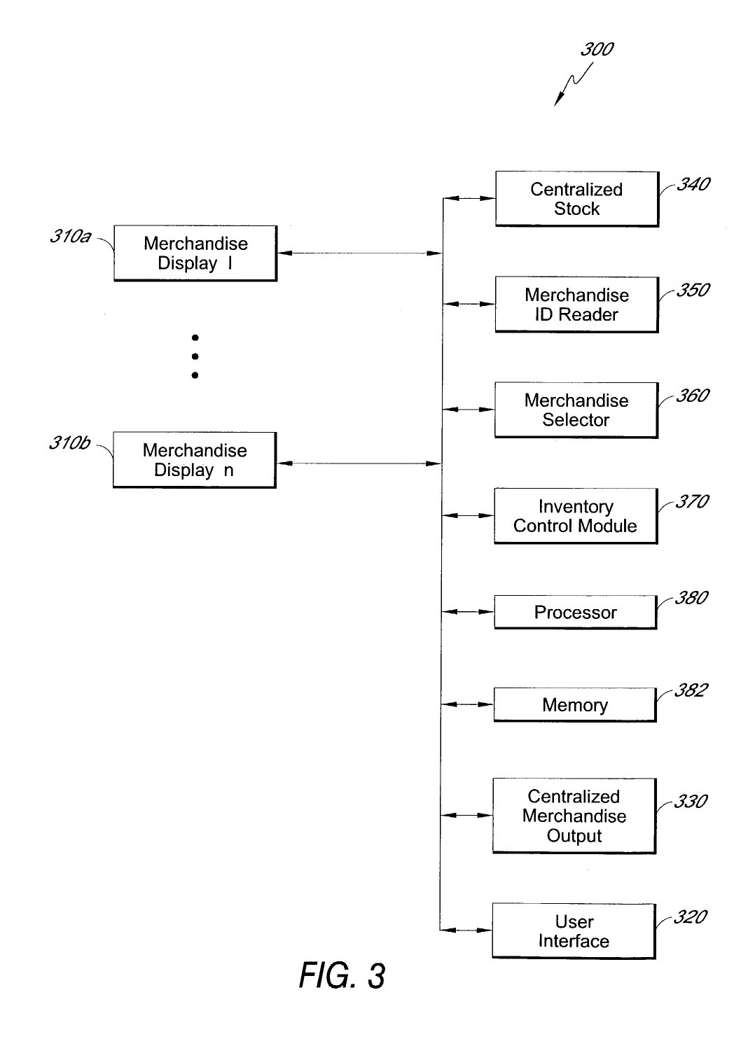

Still another functional block diagram of an embodiment of a merchandising dispenser 300 is shown in FIG. 3. As in the prior functional block diagrams, the functional blocks that are generally accessible to the user are shown on the left hand side of the block diagram. The functional blocks shown on the right hand side of the block diagram identify elements that are typically centrally located. Some of the functional blocks shown on the right hand side of the block diagram, such as, for example, the centralized stock 340 and the inventory control module, represent elements that are inaccessible to a typical user.

In this embodiment, one or more merchandise displays 310a-310b is provided in user accessible locations, such as on the sales floor. Merchandise displays 310a-310b may be segregated according to merchandise type, as is done in conventional stores. For example shoes may be displayed in a first merchandise display, shirts displayed in a second merchandise display, and tools displayed in a third merchandise display. One or more identifiers may be associated with each item of merchandise displayed. The identifiers may, but are not required to be, machine readable. Additionally, the identifiers may be the same, or different from, the machine readable ID used to identify items in the merchandising dispenser 300. Typically, the identifiers associated with the display merchandise are the SKU for the merchandise and do not identify all of the customizing information associated with the machine readable ID used in inventory control within the merchandising dispenser 300. The sample merchandise identifier may be affixed directly to the sample or may be provided on a card, tab, label, or the like. Additionally, the identifier may be provided electronically for access by the user. For example, the identifier may be stored onto a magnetic strip on a card that the user passes through at the sample merchandise location.

The user may then take the identifier, regardless of the format, to a user interface 320 to request the items. The user may also provide customization or personalization criteria, such as size, style, or color, at this time. The requested items are then dispensed from a centralized stock 340.

In the extreme example of this embodiment, only one user interface 320 and one merchandise output 330 is provided for an entire sales area stocked with sample merchandise. However, to minimize the bottleneck that would be created by such a minimal number of user interfaces and merchandise outputs, typically more than one user interface and merchandise output would be provided. The actual ratio of sample merchandise to user interfaces and to merchandise outputs would typically vary depending on the popularity of the items and the type of items available.

As shown in the functional block diagram, one or more merchandise displays 310a-310b are provided in user accessible locations. The merchandise displays are shown to be connected to the other functional blocks within the merchandising dispenser. However, the connection may be limited to an electronic database in the merchandising dispenser that is able to correlate the sample merchandise identifier with the machine readable ID associated with each item that may be stored in the centralized stock 340.

A user takes a sample merchandise identifier to the user interface 320 that reads, or otherwise accepts the identifier. The user interface 320 may accept the identifier electronically, may require manual input by the user, or may require a combination of the two. After being provided the identifier, the user interface 320 may prompt the user for one or more personalization criteria. Typically, the user would provide input that represents size, color, or style if requested.

The user request is then processed and, if the desired item is available, a merchandise selector 360 locates the item from the centralized stock 340. The merchandise selector 360 and centralized stock 340 may be similar to corresponding functional blocks described in FIG. 2.

A merchandise ID reader 350 may be used to assist locating the desired item in the centralized stock 340. Alternatively, if the machine readable ID associated with the desired item identifies a corresponding location, such as a particular bin or shelf, the merchandise ID reader 350 is not required during desired item retrieval.

The merchandise selector 360 retrieves the desired item and transports it to a centralized merchandise output 330 once the desired item is located in the centralized stock 340. The centralized merchandise output 330 may be a single merchandise output or may be a series of merchandise outputs. Typically, the series of merchandise outputs would be configured to be centrally located near the user interface 320.

An inventory control module 370 tracks merchandise stocked and dispensed from the merchandising dispenser 300. The inventory control module 370 may be connected to an external database (not shown) to which the inventory control module 370 reports inventory updates. A processor 380 and memory 382 may be configured to perform functions related to processor readable code stored within the memory 382, such as those associated with the merchandising dispenser 300. These functions may include storage and updating of the electronic record, functions relating to the user interface, functions relating to inventory control, and functions relating to the operation of each of the functional blocks in the merchandising dispenser 300.

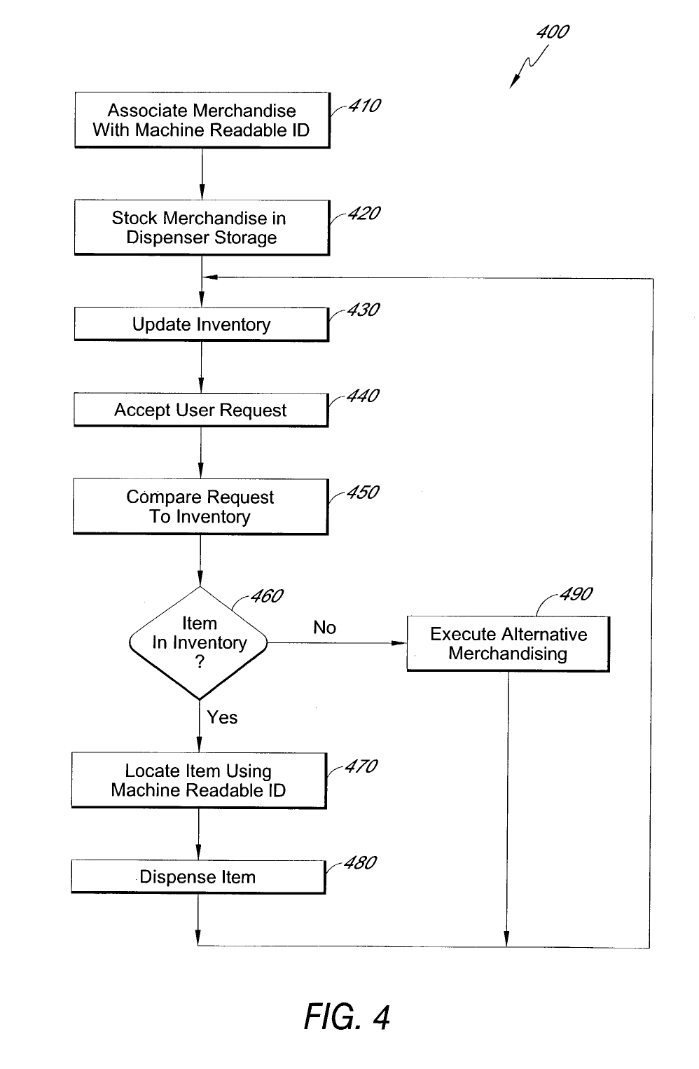

A flowchart 400 of one embodiment of the operation of the merchandising dispenser system is provided in FIG. 4. Initially, in block 410, merchandise is associated with a machine readable ID. Identification may be attached directly to the items or may be attached to a box, hanger, or bin associated with the merchandise. The association of a machine readable ID with a particular item of merchandise is typically performed by a store employee. However, the association of a machine readable ID with a particular item of merchandise may be performed by the merchandising dispenser or some other machine. Additionally, the association may be performed automatically, manually, or may require a combination of automatic and manual steps. For some items, the machine readable ID may be the stock keeping unit (SKU) number associated with the item. The item may be fully described by the SKU, such as for example, a particular pen or a particular tool. Other items may not be fully identified by the SKU number and may use a machine readable ID that is separate from the SKU. For example, the SKU typically does not identify size, color, or other identifying characteristics of an item of clothing. A machine readable ID may be associated with the item of clothing by reading the SKU and entering other identifying characteristics. Then a machine readable ID may be associated with those parameters. Continuing with the clothing example, the machine readable ID may be attached directly to the item of clothing or may be attached to a hanger or bin associated with the item of clothing.

In block 420, merchandise is stocked in a dispenser storage area after, or at the time of associating the merchandise with the machine readable ID. Although merchandise may have any form factor, merchandise is typically displayed or stored in a conventional manner. For example, clothing is available in many shapes but is typically stocked using hangers or folded and placed in bins. Items such as shoes are typically stored in boxes. Similarly, items such as power or hand tools and associated hardware, such as router bits for example, are typically stored in boxes or hung from racks using a support. Additionally, items may be stocked using a container or other stocking means adapted to be used in conjunction with a merchandising dispenser.

In one embodiment, clothing items are stocked using hangers, which may be conventional hangers, or which may be hangers adapted to be used in conjunction with the merchandising dispenser. The hangers may include mechanical features to aid in the storage and routing of items contained within the merchandising dispenser. Additionally, the hangers may include the machine readable ID with which the item of clothing is associated. The machine readable ID may be located such that it may be scanned while the hanger is supporting the item of clothing.

In another embodiment, items such as folded clothing or unconventionally shaped items may be stored in individual bins or slots within the merchandising dispenser. The bins or slots may be capable of being positioned or moved in order to facilitate routing of the stored merchandise. Each bin or slot may be identified with a machine readable ID. This ID may be the ID associated with a particular item stored in the bin or slot. In a variation on this embodiment, the merchandise is stored in a box placed within the bin or slot. The box may have affixed the machine readable ID. The boxes may be routed along with, or independent of, the particular bin or slot.

In still another embodiment, items may be stored within containers adapted for use with the merchandising dispenser. For example, items such as t-shirts or unconventionally shaped items may be stored in containers adapted for use in the dispenser. The containers may, for example, be capsules and the items stored Within the capsules. The capsules may be routed using a pneumatic tube to the desired destinations. The capsules may be removable by the consumer or may be captive within the dispenser and not removable by the consumer. Of course, the stored item may be removed from the capsule where the capsule is captive within the dispenser. Empty capsules may then be routed back to a storage area for restocking.

Thus, a merchandising dispenser configured to dispense boxed items may have a number of bins in which the boxes may be placed. A store employee stocking the dispenser may scan a barcode on the item and place it in a particular bin. Additional identifying characteristics maybe entered by the employee. The bin may also have a bar code that is scanned. Thus, the characteristics of the item are identified by the item SKU in addition to any identifying characteristic entered by the employee. By placing the item in the bin and scanning a number associated with the bin, the characteristics of the item, as well as its location, may be associated with the number of the bin.

Alternatively, items may be initially associated with machine readable IDs and then stocked into the merchandising dispenser. For example, shirts may be associated with a machine readable ID placed on the hanger on which the shirt is hung. A store employee may scan a SKU of the shirt, enter other identifying characteristics into a database, hang the shirt onto a hanger, and scan a machine readable ID affixed to the hanger. This may be duplicated for many items of clothing. Then, some or all of the previously identified shirts may be stocked into a merchandising dispenser. Because the shirts are fully identified by the machine readable IDs, there is no need to stock the items in any particular manner, such as by size or color. Instead, the items may be randomly stocked into the merchandising dispenser. Thus, the automated merchandising dispenser has the advantage that items do not need to be arranged by a store employee to be in any particular order, but rather, may be stocked in random order.

Returning to the flowchart 400 of FIG. 4, the process next proceeds to block 430 where an electronic log of the inventory stocked in the merchandising dispenser is updated. In some merchandising dispensers, this step may be performed when the item is associated with a machine readable ID. In other merchandising dispensers, this step may initially be performed as the dispenser is stocked. For example, a store employee may scan SKU numbers as products are stocked within the merchandising dispenser. The merchandising dispenser may update the electronic log of the stocked inventory as the item SKU numbers are scanned. Alternatively, a store employee may scan a machine readable ID on a hanger at the time the item on the hanger is stocked in the merchandising dispenser. In still another alternative, the merchandising dispenser scans all machine readable IDs after the dispenser is stocked. The dispenser uses the information available from the machine readable IDs to update an electronic log of the dispenser inventory. Additionally, the merchandising dispenser may use information retrieved while scanning the IDs to be able to determine a location or approximate location of each item stored in the dispenser.

The merchandising dispenser is ready to be accessed by consumers once the merchandise is stocked and the electronic log of the available inventory is updated. A merchandising dispenser running the process, at block 440, accepts a user request. The consumer typically enters the user request via a user interface. The user interface may be a graphical user interface and may include a display, and one or more input devices. As will be discussed in more detail below, the user interface may be local to the actual product dispenser location or may be remote from the product dispenser location.

An input device may be configured to accept manual entry. Manual entry devices include, but are not limited to, buttons, slides, levers, touch screens, knobs, and the like, or other means of manual entry. Other embodiments of input devices may be configured to accept electronic entry. Electronic entry devices may be configured to accept information from, for example, magnetic strips, barcodes, radio frequency devices, touch IDs, infrared links, electronic links, and the like, or some other means for electronic entry. The electronic entry devices may be configured to be associated with a particular user. For example, a user may be issued a loyalty card containing a magnetic strip. The user's shirt size may be stored in the information contained in the magnetic strip. When the user selects clothing using the magnetic strip, the merchandising dispenser may be provided the size by reading information from the magnetic strip. The loyalty card may also contain information pertaining to user preferences, payment methods, or other customizable or personalized criteria. Alternatively, the loyalty card, or loyalty device, may store a unique identification number or code and, when the user scans the loyalty card, or loyalty device, the merchandising dispenser system may access a user database that may contain the size, request history, or other personal preference information corresponding to the unique identification number.

Remote user interfaces may include web sites accessible by the consumer over the World Wide Web or some other Internet connection. Alternatively, remote user interfaces may be connected to private networks. The consumer may then access some or all of the information on the private network via the user interface. The remote user interface may be configured to allow a consumer to place an order for one or more items and have the items made available at a remote location. Alternatively, the remote user interface may allow the consumer to order and purchase one or more items for pick up or delivery. As an example, a user may place orders for desired items over the Internet and request that the items be made available at a particular store location. The user may be issued some type of identification to correlate a particular order with the user. The desired items may then be dispensed on demand once the user arrives at the store. Alternatively, items may be dispensed at the retail location and held for a specified time to allow the user the opportunity to travel to the store and pick up the merchandise.

In addition to providing an interface for the user to enter information, such as requests, the user interface may be used to provide information to the user. The information may be, for example, advertisements, notices, suggestions, pricing, or any other type of information. For example, a user may request a particular type of shirt from a merchandising dispenser. The user interface in this embodiment may then identify related merchandise based in part on the requested item or the shopper's history that may be retrieved from a loyalty card or a database linked to information on the loyalty card. The related merchandise may, for example, include other shirts of similar styles, matching pants, matching jackets, or matching accessories. The user interface may also display images of the requested and suggested items and allow the user to view various combinations together in order to assist the user in making a choice.

A user may even be able to provide an image of him or her self into the user interface to allow the user to view the requested and suggested merchandise modeled on their own image. This image may be captured at a time and location that is local to the merchandising dispenser or may be captured at a location and input into a database accessible by the merchandising dispenser. The image displayed to the user may then be based on the actual captured image or an edited form of the captured image.

In another embodiment, the user interface may be a general purpose user interface that is configured to also provide functions unrelated to the merchandising dispenser. For example, the user interface may be configured to scan merchandise from conventional displays to verify price or description of that merchandise. In another example, the user interface may allow a user to check or edit information stored on loyalty cards or other user identifiers. A user may be able to edit their personal preferences stored on the loyalty cards or may be able to verify points accumulated or special incentives available to users with loyalty cards. The user interface may also be configured to provide inducements to the user to purchase particular items. For example, purchase of a particular item may qualify a user for an identified prize, such as a trip to Paris.

The user interface may also be configured to allow store personnel to enter or verify information relating to the merchandising dispenser or system. The user interface may be used in conjunction with the stocking of the merchandising dispenser. The user interface may be used in accessing pricing, inventory, and other merchandise information. Additionally, the user interface may be configured to provide training communication, or other specific or general purpose functions, which may or may not be directly related to the operation of the merchandising dispensers.

In one embodiment, the user may request a particular item of clothing that may be dispensed from a merchandising dispenser. The user requests a particular item and enters personalization criteria that may include, for example, color, size, and style. The user may be prompted to press a particular key, for example a ‘submit’ key in order to indicate the request is complete. The merchandising dispenser then accepts the request and processes it.

The process next proceeds to a decision block 450 where the requested item is compared to the inventory available to the merchandising dispenser. In one embodiment, the request is compared to the electronic log of items in inventory. In another embodiment, the merchandising dispenser successively scans the machine readable ID of each item in inventory in an attempt to locate the item.

The process next advances to decision block 460 where the merchandise dispenser determines if the item is in inventory. The merchandise dispenser may perform this act by comparing the user request to the electronic record of inventory. Alternatively, the merchandise dispenser may perform this act by reading the machine readable ID associated with each item of merchandise stored in the dispenser.

If the item is located in inventory, the process proceeds to a block 470 where the merchandising dispenser locates the item using the machine readable ID associated with the item. In one embodiment, the item is associated with a location based on the machine readable ID. In another embodiment, the merchandising dispenser scans the machine readable ID for each successive item in the stock until the desired item is located. For example, a merchandising dispenser configured to store shirts on hangers may scan a machine readable ID on a hanger in an attempt to locate a requested item.

Once the item is located, the process proceeds to a block 480 where the item is dispensed. The dispenser may be at a location that is local to the user interface or the dispenser may be at a location remote from the user interface. For example, the requested item may be dispensed at a remote dressing room location for the user to try on. An item dispensed to a fitting room may be dispensed to a secure fitting room that is accessed by the user by using a code or loyalty device. Once the item is dispensed, the process returns to block 430 where the inventory is updated to indicate an item is no longer available.

Returning to decision block 460, if the requested item is not in inventory available to the merchandising dispenser, the flowchart proceeds to block 490 where the merchandising dispenser executes an alternative merchandising procedure. The alternative merchandising procedure may perform a variety of tasks that the retailer may wish to have occur if the requested item is not available to the merchandising dispenser.

For example, the user interface may indicate that the item is not in stock and offer to order the item for later pick up at the store. Alternatively, the merchandising dispenser may have access to a larger database of items, including those items not within the stock available to the merchandising dispenser. This larger database may indicate items that are stored in back room areas of the store, or the larger database may include the inventory from multiple merchandising dispensers or multiple stores.

The user interface may be configured to direct the user to an alternative location, such as another store or another merchandising dispenser. The alternative merchandising procedure may alternatively notify a customer service representative to retrieve the requested item from a back room location. The customer service representative may be notified using, for example, a pager, a walkie-talkie or other radio, a personal digital assistant, a wireless phone, a display, or other means for notifying the representative. There are many alternative merchandising procedures that may be executed and those embodiments described above only represent examples.

After executing the alternative merchandising procedure, the flowchart returns to block 430 where the inventory is updated. Because no inventory from the merchandising dispenser was dispensed, the inventory of stock available to the merchandising dispenser does not need to be updated. However, if the merchandising dispenser has access to a larger database, and items from the larger database are identified to allow delivery to a customer, the merchandising dispenser may have the ability to update the larger database.

By updating the inventory after each transaction, the retailer is able to accurately track inventory on a real time basis. Clothing items that are tried on and not purchased may be re-associated with a machine readable ID and reloaded into merchandise dispensers.

Thus, a merchandising dispenser, a system of merchandise dispensing, and a method of dispensing merchandise have been disclosed. The system and method may be used to organize materials, devices, or products to permit quick and accurate retreival of requested items.

An automated merchandise dispenser may be stocked with items that may be automatically dispensed to users upon demand. The inventory stocked in the merchandising dispenser may represent substantially the entire inventory for a particular type of merchandise. A user enters a request for a desired item using a user interface. The user may also enter personalization criteria such as, for example, color, size, style, and the like.

The merchandising dispenser accepts the user request and locates the desired merchandise using machine readable ID associated with each stocked item or informs the user that the item is not available. The merchandise dispenser dispenses desired items to the user to enable the user to purchase, try on, or otherwise examine the desired item.

Typically, the user does not need to purchase the item prior to the item being dispensed. However, in some instances prepayment may be required before an item is dispensed. Such as system, apparatus, and method provides many advantages over conventional merchandising approaches.

Electrical connections, couplings, and connections have been described with respect to various devices or elements. The connections and couplings may be direct or indirect. A connection between a first and second device may be a direct connection or may be an indirect connection. An indirect connection may include interposed elements that may process the signals from the first device to the second device.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons may implement the described functionality in varying ways for each particular application, but such implementation decisions should not be interpreted as causing a departure from the scope of the invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

The above description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. A merchandise dispenser comprising:
a merchandise stock configured to store at least one item of merchandise, each item of merchandise associated with a machine readable identification;
a merchandise display configured to display a merchandise sample;
a user interface configured to accept a request for a desired item;
an inventory control module configured to receive the request from the user interface and to compare the request to a record of merchandise available within the merchandise stock; and
a merchandise selector in communication with the inventory control module, the merchandise selector configured to locate the desired item within the merchandise stock based in part on the machine readable identification associated with the desired item, retrieve the desired item from the merchandise stock, and dispense the desired item.

2. The merchandise dispenser of claim 1, wherein the inventory control module is configured to update the record of merchandise if the merchandise selector dispenses the desired item.

3. The merchandise dispenser of claim 1, wherein the inventory control module is further configured to update the record of merchandise when items of merchandise are added to the merchandise stock.

4. The merchandise dispenser of claim 1, wherein the request for the desired item comprises customization criteria provided via the user interface.

5. The merchandise dispenser of claim 4, wherein the customization criteria comprises a size of the desired item.

6. The merchandise dispenser of claim 4, wherein the customization criteria comprises a color of the desired item.

7. The merchandise dispenser of claim 4, wherein the customization criteria comprises a style of the desired item.

8. The merchandise dispenser of claim 1, wherein each item of merchandise stored within the merchandise stock is associated with a machine readable identification code that is unique for items available through that dispenser.

9. The merchandise dispenser of claim 1, wherein one or more items of merchandise stored within the merchandise stock may have a same machine readable identification code.

10. The merchandise dispenser of claim 1, wherein the machine readable identification comprises information identifying customization criteria.

11. The merchandise dispenser of claim 10, wherein the customization criteria comprises a size of the merchandise associated with the machine readable identification.

12. The merchandise dispenser of claim 10, wherein the customization criteria comprises a color of the merchandise associated with the machine readable identification.

13. The merchandise dispenser of claim 10, wherein the customization criteria comprises a style of the merchandise associated with the machine readable identification.

14. The merchandise dispenser of claim 1, wherein each item of merchandise is associated with its machine readable identification by having the machine readable identification affixed to the item.

15. The merchandise dispenser of claim 1, wherein each item of merchandise is associated with its machine readable identification by having the machine readable identification affixed to a storage location of the item.

16. The merchandise dispenser of claim 1, wherein each item of merchandise is associated with its machine readable identification by having the machine readable identification affixed to a container which contains the item.

17. The merchandise dispenser of claim 1, wherein each item of merchandise is associated with its machine readable identification by having the machine readable identification affixed to a support used to locate the item within the merchandise stock.

18. The merchandise dispenser of claim 17, wherein the support comprises a hanger.

19. The merchandise dispenser of claim 1, wherein the machine readable identification comprises a bar code.

20. The merchandise dispenser of claim 1, further comprising an identification reader in communication with the merchandise selector, the identification reader configured to read the machine readable identification.

21. The merchandise dispenser of claim 20, wherein the merchandise selector locates the desired item, in part, by directing the identification reader to successively read the machine readable identification of each item in the merchandise store.

22. The merchandise dispenser of claim 1, further comprising an identification reader in communication with the inventory control module, the identification reader configured to read the machine readable identification associated with each item of merchandise stored in the merchandise stock and communicate the identification to the inventory control module for updating of the record.

23. The merchandise dispenser of claim 1, wherein the merchandise stock comprises a plurality of storage areas configured to store items of merchandise.

24. The merchandise dispenser of claim 23, wherein each of the storage areas comprises a bin.

25. The merchandise dispenser of claim 23, wherein each of the storage areas comprises a shelf.

26. The merchandise dispenser of claim 1, wherein the merchandise stock is at a location that is local to the user interface.

27. The merchandise dispenser of claim 1, wherein the merchandise stock is at a location that is remote from the user interface.

28. The merchandise dispenser of claim 27, further comprising a transport mechanism configured to transport the desired item from the merchandise stock to a merchandise output.

29. The merchandise dispenser of claim 28, wherein the merchandise output is at a location that is local to the user interface.

30. The merchandise dispenser of claim 28, wherein the merchandise output is at a location that is remote from the user interface.

31. The merchandise dispenser of claim 1, wherein the merchandise display comprises a screen configured to display an image of the merchandise sample.

32. The merchandise dispenser of claim 1, wherein the merchandise display comprises a display case configured to hold the merchandise sample.

33. The merchandise dispenser of claim 1, wherein the user interface comprises a keypad.

34. The merchandise dispenser of claim 1, wherein the user interface comprises a touch screen, and wherein the touch screen is configured as the merchandise display.

35. The merchandise dispenser of claim 1, wherein the user interface is further configured to accept a request for a dispense location.

36. The merchandise dispenser of claim 35, wherein the dispense location is local to the merchandise dispenser.

37. The merchandise dispenser of claim 35, wherein the dispense location is remote from the merchandise dispenser.

38. The merchandise dispenser of claim 1, wherein the user interface is further configured to provide an out-of-stock indication if the inventory control module determines the desired item is not in the record of merchandise available.

39. The merchandise dispenser of claim 38, wherein the user interface is further configured to output a list of alternative merchandise if the inventory control module determines the desired item is not in the record of merchandise available.

40. The merchandise dispenser of claim 1, wherein the user interface is further configured to output a list of related merchandise based in part on the request for the desired item.

41. The merchandise dispenser of claim 1, wherein the user interface is further configured to accept data from a loyalty card.

42. The merchandise dispenser of claim 41, wherein the loyalty card is configured to store customization criteria.

43. The merchandise dispenser of claim 42, wherein the user interface is further configured to automatically append at least some of the customization criteria stored within the loyalty card to the request for the desired item.

44. A merchandise dispenser comprising:
a merchandise stock configured to store at least one item of merchandise, each item of merchandise associated with a machine readable identification, the machine readable identification identifying customization criteria for the associated item of merchandise;
a plurality of user interfaces, each user interface configured to accept a request for a desired item, the request including customization criteria;
an inventory control module configured to receive the request from the plurality of user interfaces and to compare the request to an electronic record of merchandise stored within the merchandise stock;
a merchandise selector in communication with the inventory control module, the merchandise selector configured to locate the desired item within the merchandise stock based in part on the machine readable identification associated with the desired item, and retrieve the desired item from the merchandise stock; and
a transport mechanism configured to transport the desired item retrieved by the merchandise stock to a merchandise output and to dispense the desired item.

45. The merchandise dispenser of claim 44, wherein the merchandise stock is configured to store items of clothing supported on hangers, each hanger having affixed thereto the machine readable identification associated with the item of clothing supported by the hanger.

46. The merchandise dispenser of claim 44, wherein the merchandise stock is configured to store items of merchandise in individual bins, each individual bin labeled with the machine readable identification associated with the item of merchandise stored within the bin.

47. A method of dispensing items of merchandise, the method comprising:
storing items of merchandise within a merchandise stock, each item of merchandise associated with a machine readable identification;
updating an electronic record of items of merchandise stored within the merchandise stock;
receiving an electronic request for a desired item;
determining whether the desired item is stored in the merchandise stock by comparing the electronic request with items identified in the electronic record;
locating the desired item within the merchandise stock based in part on the machine readable identification; and
dispensing the item.

48. The method of claim 47, wherein the act of storing items of merchandise within the merchandise stock comprises:
receiving one or more characteristics of each item of merchandise into a memory;
identifying the one or more characteristics for each item of merchandise with the machine readable identification; and
storing each item of merchandise in a machine retrievable location.

49. The method of claim 48, wherein the one or more characteristics comprises customization criteria.

50. The method of claim 48, wherein the act of receiving one or more characteristics of each item of merchandise comprises receiving a stock keeping unit (SKU) identification for each item of merchandise.

51. The method of claim 50, further comprising receiving one or more customization criteria for each item of merchandise.

52. The method of claim 47, wherein the machine readable identification for each item stored in the merchandise stock comprises a unique identification code.

53. The method of claim 47, further comprising automatically updating the electronic record to indicate the desired item is no longer stored in the merchandise store.

54. The method of claim 47, wherein the act of locating the desired item within the merchandise stock comprises:
determining a location of the desired item based in part on the machine readable identification associated with the desired item;
retrieving, using an automated merchandise selector, the desired item from the location; and
transporting the desired item to a merchandise output.

55. The method of claim 54, wherein transporting the desired item to the merchandise output comprises transporting the desired item to a location that is local to the user interface in which the electronic request originated.

56. The method of claim 54, wherein transporting the desired item to the merchandise output comprises transporting the desired item to a location that is remote from the user interface in which the electronic request originated.

57. The method of claim 54, wherein the act of determining the location of the desired item comprises:
identifying a location of a first item stored in the merchandise store, the location of the first item stored in the electronic record;
reading the machine readable identification for the first item; and
determining whether the first item is the desired item.

58. The method of claim 57, further comprising:
identifying a location of a second item stored in the merchandise store, the location of the second item based in part on the location of the first item;
reading the machine readable identification for the second item; and
determining whether the second item is the desired item.

59. A merchandise dispenser, comprising:
means for storing items of merchandise, each item of merchandise associated with a machine readable identification;
means for updating an electronic record of items of merchandise stored within the means for storing items of merchandise;
means for receiving an electronic request for a desired item;
means for determining whether the desired item is stored in the means for storing items of merchandise by comparing the electronic request with items identified in the electronic record;
means for locating the desired item within the means for storing items of merchandise based in part on the machine readable identification; and
means for dispensing the item.

60. The merchandise dispenser of claim 59, further comprising:
means for receiving one or more characteristics of each item of merchandise into a memory;
means for identifying the one or more characteristics for each item of merchandise with the machine readable identification; and
means for storing each item of merchandise in a machine retrievable location.

61. The merchandise dispenser of claim 60, wherein the one or more characteristics comprises customization criteria.

62. The merchandise dispenser of claim 60, wherein the means for receiving one or more characteristics of each item of merchandise comprises receiving a stock keeping unit (SKU) identification for each item of merchandise.

63. The merchandise dispenser of claim 62, further comprising means for receiving one or more customization criteria for each item of merchandise.

64. The merchandise dispenser of claim 59, wherein the machine readable identification for each item stored in the merchandise stock comprises a unique identification code.

65. The merchandise dispenser of claim 59, further comprising means for automatically updating the electronic record to indicate the desired item is no longer stored in the means for storing items of merchandise.

66. The merchandise dispenser of claim 59, wherein the means for locating the desired item within the merchandise stock comprises:
means for determining a location of the desired item based in part on the machine readable identification associated with the desired item;
means for retrieving, using an automated merchandise selector, the desired item from the location; and
means for transporting the desired item to a merchandise output.

67. The merchandise dispenser of claim 66, wherein the means for transporting the desired item to the merchandise output comprises means for transporting the desired item to a location that is local to the user interface in which the electronic request originated.

68. The merchandise dispenser of claim 66, wherein the means for transporting the desired item to the merchandise output comprises means for transporting the desired item to a location that is remote from the user interface in which the electronic request originated.

69. The merchandise dispenser of claim 66, wherein the means for determining the location of the desired item comprises:
means for identifying a location of a first item stored in the means for storing items of merchandise, the location of the first item stored in the electronic record;
means for reading the machine readable identification for the first item; and
means for determining whether the first item is the desired item.

70. The merchandise dispenser of claim 69, further comprising:
means for identifying a location of a second item stored in the means for storing items of merchandise, the location of the second item based in part on the location of the first item;
means for reading the machine readable identification for the second item; and
means for determining whether the second item is the desired item.
